(19) United States
(12) Patent Application Publication
(10) Pub. No.: US 2010/0114866 A1
(43) Pub. Date: May 6, 2010

(54) CREATING AND ADMINISTERING A PROCESS STUDY

(75) Inventor: Shankar Saravanan, Boston, MA (US)

Correspondence Address: PROSKAUER ROSE LLP, ONE INTERNATIONAL PLACE, BOSTON, MA, 02110, US

(73) Assignee: FMR LLC, Boston, MA (US)

(21) Appl. No.: 12/258,364

(22) Filed: Oct. 24, 2008

(51) Int. Cl. G06F 17/30

(52) U.S. Cl. 707/713; 707/E17.017

(57) ABSTRACT

Described are computer-based methods and apparatuses, including computer program products, for creating and administering a process study. An administrator creates and configures a process study on a site on a network. A server on the network creates a process sampling module based on the process study. Participants in the study install the process sampling modules on their end client computing devices. The process sampling modules collect process sampling data from the participants and transmit the data to the server for collection.

### FIELD OF THE INVENTION

The present invention relates generally to computer-based methods and apparatuses, including computer program products, for creating and administering a process study. In some of the described embodiments, the process studies use process sampling modules that reside on end client computing devices to collect data about processes, and the process sampling modules transmit the data to a central location to be analyzed.

### BACKGROUND

When an organization seeks to analyze processes, the organization can send personnel to conduct on-site observations. The organization notifies the different worksites that personnel will be arriving at designated times. The personnel travel to the worksites and walk around carrying data collecting materials such as stopwatches, paper surveys, or electronic handheld data collection devices. The personnel stop at various locations at the worksite and record information about the process or stage of the process at the location. After the personnel return from the different worksites, they aggregate the collected data by, for example, entering the data into a master database. The personnel then study the aggregated data to analyze the processes.

Alternatively, the organization can use technology to record information about worksites. Personnel travel to the different worksites and install recording technology in various locations around each worksite. The recording technology continually captures information about the worksite for a designated period of time. The personnel retrieve the recording technology, watch the recorded information, and collect data about the processes they observe on the recorded media. The personnel then aggregate the data from the various worksites and analyze the processes.

### SUMMARY OF THE INVENTION

One aspect of creating and administering a process study is through a computerized method of configuring a process sampling module. The method includes receiving a first set of information associated with a first query at a computing device that is generating an administrator interface. The method also includes storing the first set of information in persistent memory to set entries for the first query based on the first set of information. The method also includes receiving a second set of information associated with a second query at the computing device that is generating the administrator interface. The method also includes storing the second set of information in persistent memory to set entries for the second query based on the second set of information. The method also includes creating and storing in persistent memory a relationship between an entry for the first query and a subset of the entries for the second query. The method also includes using the entries for the first query, the entries for the second query, and the relationship to create the process sampling module for collecting process data for a process study.

Another aspect of creating and administering a process study is through a computing device configured to receive a first set of information to set entries for a first query, a second set of information to set entries for a second query, and a relationship between an entry for the first query and a subset of the entries for the second query.

Another aspect of creating and administering a process study is through a persistent memory configured to store a first set of information to set entries for a first query, a second set of information to set entries for a second query, and a relationship between an entry for the first query and a subset of the entries for the second query.

Another aspect of creating and administering a process study is through an administrator interface for configuring a process sampling module. The administrator interface includes means for displaying entries for a first query on a computer. The administrator interface also includes means for displaying entries for a second query on a computer. The administrator interface also includes means for creating and storing in persistent memory a relationship between an entry for the first query and a subset of the entries for the second query.

Another aspect of creating and administering a process study is through a computerized method of collecting process sampling data with a process sampling module. The method includes receiving process sampling data input into an end client computing device from a participant. The method also includes determining if the end client computing device and a server can communicate. The method also includes transmitting the received process sampling data to the server if the end client computing device and the server can communicate. The method also includes storing the received process sampling data on the end client computing device if the end client computing device and the server cannot communicate.

Another aspect of creating and administering a process study is through a process sampling module. The process sampling module includes a user interface generating module for displaying a user interface and receiving process sampling data input by a participant from an end client computing device. The process sampling module also includes a communication module for determining whether the end client computing device can communicate with a server, wherein the process sampling module transmits the received process sampling data to the server if the end client computing device and server can communicate. The process sampling module also includes a data storage module for storing the received process sampling data on the end client computing device if the end client computing device and server cannot communicate.

Any of the aspects above can include one or more of the following features. In some examples, the randomization of the process sampling can be set. The randomization can be a cycle time for a process sample, a predetermined number of process samples in a predetermined period of time, or entry at will. The period of time for which the processing sample module will be active can be set. The means for selecting the entry for the first query or the second query can be set. The participants who will use the process sampling module can be specified by, for example, uploading a file of participants or entering information about individual participants. The order of the queries can be set.

In some examples, the end client computing device can be searched for stored process sampling data. The stored process sampling data can be transmitted to the server if the end client computing device and server can communicate. The participant can be signaled to enter process sampling data. The signaling can occur according to a randomization. The signaling can be flashing or beeping. The signaling can occur at a first predetermined period of time after the process sampling module changes from an inactive status to an active status. The active status can be working or at desk. The inactive status can be out of office, away, or inactive. The first predetermined period of time can be two minutes. A non-response can be recorded if process sampling data is not received after a second predetermined period of time. The process sampling data can be designated for one or more process studies at the server.

In some examples, the process sampling module can search the end client computing device for stored process sampling data. The process sampling module retrieves stored process sampling data from the end client computing device and transmits the stored process sampling data when the communication module determines that the end client computing device and server can communicate. The module can be in an active status or an inactive status. The active status can be working or at desk. The inactive statuses can be out of office, away, or inactive. The module can signal for the user to enter process sampling information at a first predetermined period of time after the module changes from an inactive status to an active status. The first predetermined period of time can be two minutes. The module can signal by flashing or beeping. The module can record a non-response if the module does not receive process sampling information after a second predetermined period of time. The module can send the process sampling information to one or more process studies on the server. The module can signal for process sampling information according to a predetermined randomization.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a functional block diagram of a network system for creating and administering a process study.

FIG. 2 is an exemplary screenshot of an exemplary administrator interface displayed on an administrator site.

FIG. 3 is an exemplary screenshot of an exemplary administrator interface displayed on the administrator site for creating a rollout or editing information for a pre-existing rollout.

FIG. 4 is an exemplary screenshot of an exemplary administrator interface displayed on the administrator site for configuring a rollout.

FIG. 5 is an exemplary screenshot of an exemplary administrator interface displayed on the administrator site for adding participants to a process study.

FIG. 6 is an exemplary screenshot of an exemplary administrator interface displayed on the administrator site for adding a query to a process study.

FIG. 7 is an exemplary screenshot of an exemplary administrator interface displayed on the administrator site for editing or configuring a query.

FIG. 8 is an exemplary screenshot of an exemplary administrator interface displayed on the administrator site for adding entries to a query.

FIG. 9 is an exemplary file including entries for two queries and the relationship between the queries.

FIG. 10A is an exemplary screenshot of an exemplary administrator interface displayed on the administrator site for configuring a relationship between two queries.

FIG. 10B is an exemplary screenshot of an exemplary administrator interface displayed on the administrator site for configuring a relationship between two queries.

FIG. 11 is a block diagram of an exemplary process sampling module present on a participant's end client computing device that communicates with a server.

FIG. 12 illustrates an exemplary method of storing process sampling data collected by the process sampling module.

FIGS. 13, 14, and 15 are exemplary screenshots of user interfaces that can be generated and displayed by the process sampling module.

### DETAILED DESCRIPTION

In general overview, a process study can be organized and administered through a network. An administrator creates and configures a process study (also known as a “rollout,” and the terms will be used interchangeably) through a site on the network. A network server creates a module based on the process study (also known as a process sampling module, a process sampling tool, or a widget) and notifies participants in the process study to obtain the module. The participants install the module from the network server onto their end client computing devices. The module collects process sampling data from the participants and transmits the collected data over the network to the network server. If the end client computing device cannot communicate with the network server, the module stores the collected data on the end client computing device until communication with the network server becomes possible. When the process study ends, collected data on the network server is analyzed to study the process.

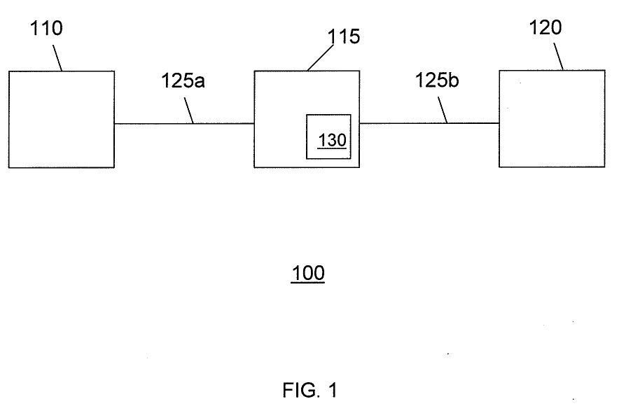

FIG. 1 is a functional block diagram of a network system 100 for creating, which can include configuring, and administering a process study. The network system 100 includes an administrator site 110, a network server 115 with a storage unit 130, and a participant services site 120. A process study administrator uses the administrator site 110 to create and configure a process study and to specify participants in the process study. The network server 115 creates and stores a process sampling module based on the process study. The participants use the participant services site 120 to download and install the process sampling module on their end client computing devices. The process sampling module collects process sampling data from the participants and sends the data over the network to be stored in the storage unit 130.

The administrator site 110 includes, for example, a computing device with a display device and one or more devices for user input. The participant site 120, e.g., an end client computing device, includes, for example, a computing device with a display device and one or more devices for user input. The administrator site 110 and the participant site 120 communicate with the network server 115 using communication networks 125a and 125b, respectively. The communication networks 125a and 125b can be part of the same network or can be different networks. The administrator site 110, the server 115, and the participant site 120 can represent a single device or multiple devices.

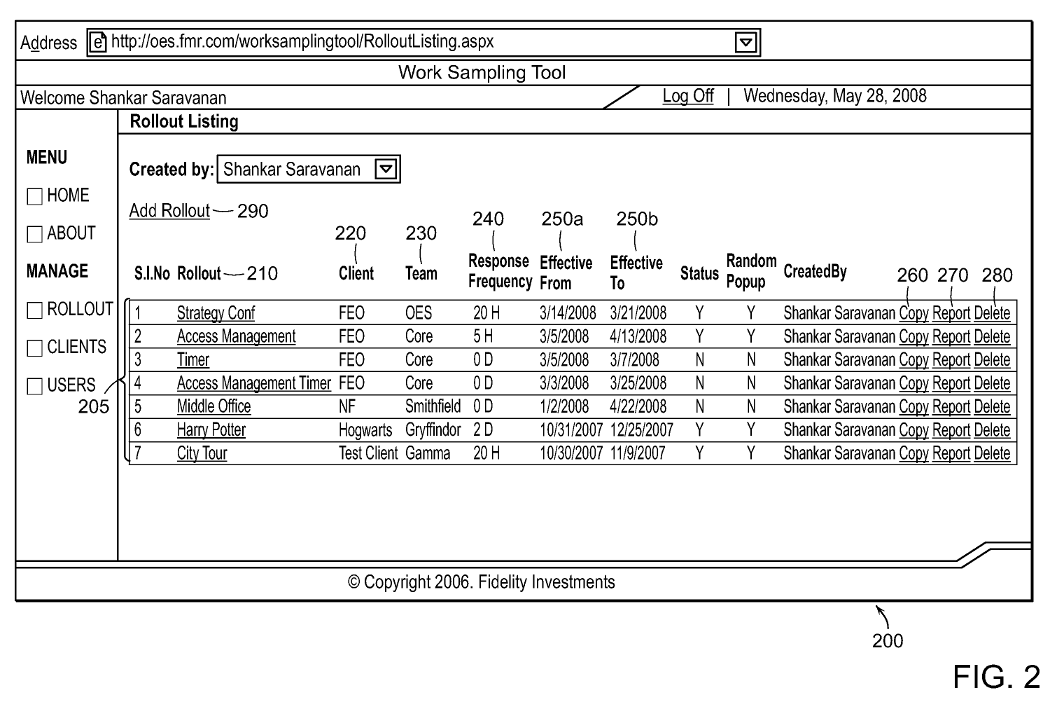

FIG. 2 is an exemplary screenshot 200 of an exemplary administrator interface displayed on an administrator site 110. The system 100 generates, e.g., via network server 115, the screenshot 200 when, for example, the administrator logs in using, for example, an administrator log-in interface (not shown). The screenshot 200 lists rollouts 205 that the administrator previously created and configured. The screenshot 200 includes fields displaying information about the rollouts. The fields include a rollout name field 210, a client name field 220, a team name field 230, a response frequency field 240, and rollout effectiveness date fields 250a and 250b (collectively, “250”). Each rollout 205 includes an associated copy button 260, report button 270, and delete button 280. If the administrator selects the copy button 260 associated with a rollout, a duplicate rollout is created and configured according to that rollout. If the administrator selects the report button 270 associated with a rollout, the administrator site retrieves data collected for the rollout from the storage unit 130 and generates a report, such as a spreadsheet aggregating all the stored data. This report can be displayed and/or printed. If the administrator selects the delete button 270 associated with a rollout, the rollout is deleted.

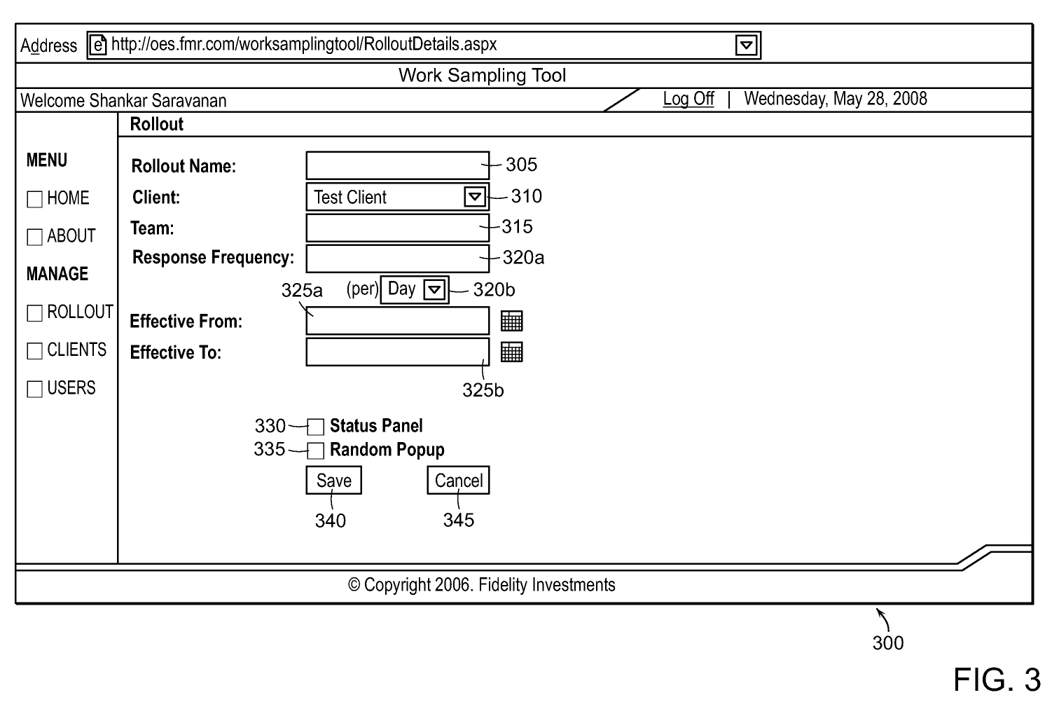

The screenshot 200 also includes an add rollout button 290. As used in this specification, the term “button” can refer to any user interface element for which a user action, such as moving a cursor over the button and pressing a button on a pointer device, can cause an action to be taken. For the rollout button 290, and in other examples in the specification, the button is in the form of a hyperlink. By clicking on the add rollout button, the administrator can create a new rollout. Clicking on the add rollout button can, for example, can cause the system 100 to generate an administrator interface such as the screenshot 300 of FIG. 3.

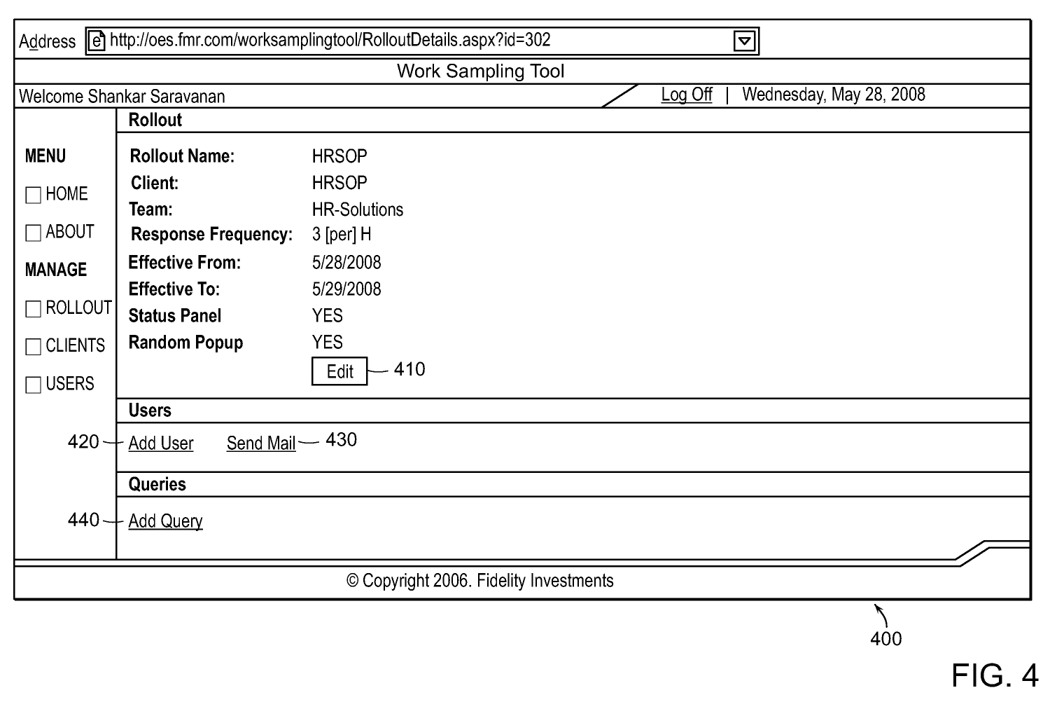

The screenshot 200 also enables the administrator to configure a rollout, including the ability to edit the rollout information, by clicking on a rollout name. Clicking on a rollout name can, for example, can cause the system 100 to generate an administrator interface such as the screenshot 400 of FIG. 4.

FIG. 3 is an exemplary screenshot 300 of an exemplary administrator interface displayed on an administrator site 110 for creating a rollout or editing information for a pre-existing rollout. The screenshot 300 includes fields that receive information for the rollout. The fields include a rollout name field 305, a client field 310, a team field 315, response frequency fields 320a and 320b (collectively, “320”), rollout effectiveness date fields 325a and 325b (collectively, “325”), a status panel check box 330, a random popup check box 335, a save button 340, and a cancel button 345. Although the screenshot 300 displays particular fields as text boxes, drop-down menus, check boxes, and buttons, any means for inputting data into a user interface can be used.

In some examples, the administrator inputs alphanumeric text into the rollout name field 305 to specify a name for the rollout. The administrator enters the client name by selecting a client from a drop-down menu in the client field 310. If the client is not included in the drop-down menu, the administrator can enter information about the client into a client management screen (not shown). Entering the information into the client management screen can add the client to the drop-down menu of the client field 310, or the administrator can opt not to store the client information. The administrator enters the team name in the team field 315. The administrator designates how often the rollout will collect data, also known as the randomization, in the response frequency fields 320. One response frequency field 320a receives the number of times the rollout will request data within a cycle time, and another response frequency field 320b receives the cycle time. For example, the response frequency can be a particular number of samples in a day, week, or month.

In some examples, the administrator enters the dates for the process sampling study in the rollout effectiveness date fields 325. Rollout effectiveness date field 325a receives the beginning date of the study and rollout effectiveness date field 325b receives the end date of the study, i.e. the period of time when a process sampling module based on the process study will be active. The administrator can select the beginning and end dates by entering text into the appropriate field or by selecting dates on a pop-up calendar. Checking the status panel check box 330 adds a status panel to the processing sampling module that enables the participant to temporarily inactivate the process sampling module when, for example, the participant is away from his or her desk. The status panel will be discussed in further detail below. Checking the random popup check box 335 sets the processing sampling module's sampling to the randomized response frequency in response frequency fields 320. The random popup feature will be discussed in further detail below.

If the administrator decides not to create a new rollout, the administrator can click (e.g., use a pointing device to move a cursor over the selected button and press a button on the pointing device) the cancel button 345 to prevent the rollout from being created and/or saved. If the administrator reached the screenshot 300 by electing to edit information for a pre-existing rollout, clicking the cancel button 345 will cause the system 100 to ignore the changes made in the fields of the screenshot 300.

When the administrator has finished entering information for the rollout into the appropriate fields, the administrator can save the information by clicking on the save button 340. Clicking on the save button 340 stores the information for the rollout, for example on the storage unit 130. The system 100 can then generate another administrator interface, such as screenshot 400 of FIG. 4, which can be displayed on administrator site 110.

FIG. 4 is an exemplary screenshot 400 of an exemplary administrator interface displayed on the administrator site 110 for configuring a rollout. Screenshot 400 includes information for a rollout, an edit button 410, an add user button 420, a send mail button 430, and an add query button 440. In some examples, screenshot 400 can also include an edit query button (not shown) whose selection can cause all the queries in the rollout to be listed and individual queries to be selected for editing. The system 100 generates screenshot 400, for example, in response to the administrator selecting a rollout from screenshot 200 (e.g., clicking on a link 205) or creating a new rollout using screenshot 300 (e.g., clicking on the save button 340). The administrator can review information for a rollout. If any of the rollout information is incorrect or has changed since the rollout was created, the administrator can edit the information by selecting the edit button 410. In some examples, the system 100 returns to and displays screenshot 200 and the administrator can edit and save information for the rollout as desired.

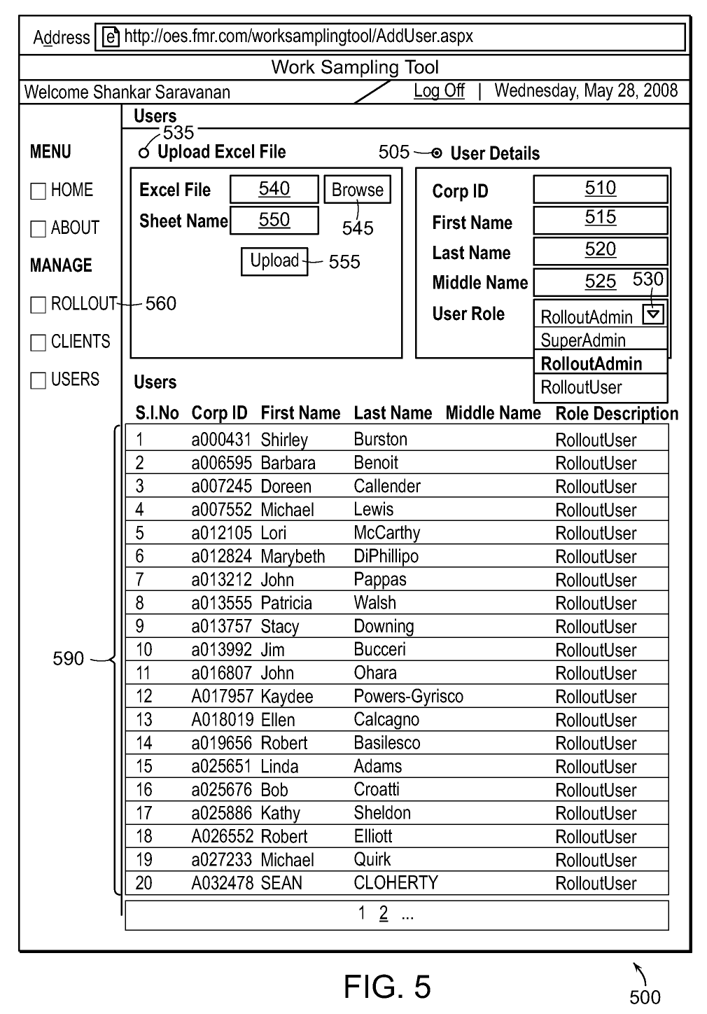

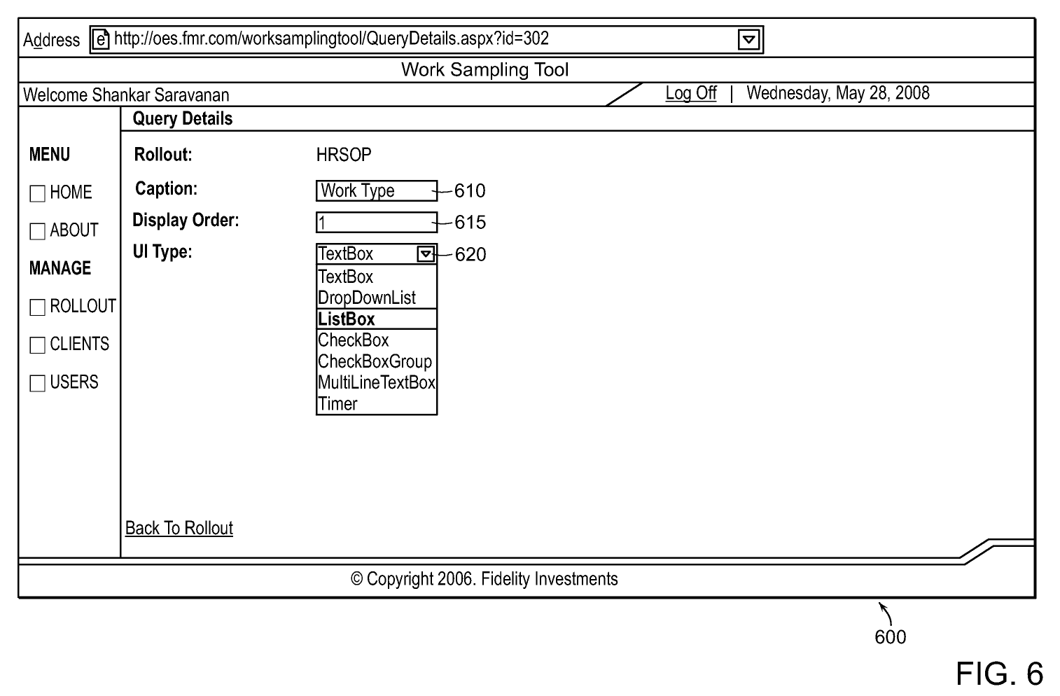

The administrator can click on the add user button 420 to specify participants in the process study. Clicking on the add user button 420 causes the system 100 to generate a screenshot for specifying participants, such as screenshot 500 of FIG. 5. The administrator can click on the add query button 440 to specify data to be collected. Clicking on the add query button causes the system 100 to generate a screenshot for adding a query, such as screenshot 600 of FIG. 6. When the administrator has finished configuring the process study and specifying participants, the administrator can click on the send mail button 430 to begin distribution of the process sampling modules for the study. The network server 115 can store a process sampling module and send to each participant a message with a link to a network site (e.g. a Self Service Installation link). From the network server 115, each participant can download the process sampling module onto his or her end client computing device (e.g., participant site 120). The process sampling module is described in further detail below.

FIG. 5 is an exemplary screenshot 500 of an exemplary administrator interface displayed on an administrator site 110. The screenshot 500 includes a list 590 of people already added as participants in the process study, also referred to as users associated with the study. If the rollout has just been newly created, the list 590 will be empty. The screenshot 500 also includes a user details radio button 505, a corporate identification field 510, a first name field 515, a last name field 520, a middle name field 525, a user role field 530, an upload Excel file radio button 535, an Excel file name field 540, a browse button 545, a sheet name field 550, and an upload button 555. Although the screenshot 500 displays particular fields as text boxes, drop-down menus, and buttons, any means for inputting data into a user interface can be used.

Selection of the user details radio button 505 enables the administrator to insert information about individual participants manually, whereas selection of the upload Excel file radio button 535 enables the administrator to upload a file with information for multiple participants to be added to the study. In some examples, selection of one radio button disables the ability to select the other, although the administrator can enter information for some participants manually and for others by uploading a file, if so desired.

If the administrator elects to enter participant information individually, after selecting the user details radio button 505, the administrator enters identifying information about the participant. In this example, the administrator enters the participant's corporate identification number in the corporate identity field 510, the participant's first name in the first name field 515, and the participant's last name in the last name field 520. The administrator further specifies the person as a participant in the process study by setting the value in the user role field 530 to “RolloutUser.” The administrator can optionally enter the participant's middle name in the middle name field 525. In other examples, additional or different identifying information about the participants can be entered and collected. In some examples, the upload button 555 remains inactive (e.g. grayed out) until all the required information about a participant has been entered. When the required information has been entered, the upload button 555 becomes active (e.g. black), and the administrator can click on the upload button 555 to add the participant to the process sampling study.

If the administrator elects to enter information about multiple participants saved in a file, the administrator can upload the file. The administrator first selects the upload Excel file radio button 535 and enters the name of the file. In this example, the administrator can enter the name of the file by typing the name into the Excel file name field 540 or by searching for the file. By clicking on the browse button 545, the administrator can search through file directories and select the desired file when found. The name of the selected file then appears in the Excel file name field 540. If desired, the administrator can also enter a sheet name in the sheet name field 550 to distinguish the file being uploaded from others that have or will be uploaded. As when participants are individually added, the upload button 555 can remain inactive (e.g. grayed out) until a file name has been entered in the Excel file name field 540. The administrator clicks on the upload button 555 to submit the file to the network server 115. The network server 115 reads the file, parses the contents of the file into identifying information for each participant, and stores the identifying information for each participant on the storage unit 130. If the file cannot be parsed, the screenshot 500 displays an error message to the administrator.

When the administrator finishes adding participants to the process study, the administrator can cause the system 100 to return to a different interface, such as screenshot 400, for example by clicking on the “ROLLOUT” button 560.

FIG. 6 is an exemplary screenshot 600 of an exemplary administrator interface displayed on the administrator site 110 for adding a query to a process study. Screenshot 600 can appear, for example, when the administrator selects the add query button 440 on screenshot 400. In another example, screenshot 600 can appear when the administrator seeks to edit a query. Screenshot 600 displays the name of the rollout and includes input fields to receive information about the query from the administrator. Screenshot 600 includes a caption field 610, a display order field 615, and a user interface (UI) type field 620, although fields that receive other types of information can also be included or substituted. Screenshot 600 also includes an insert button (not shown). Although the screenshot 600 displays particular fields as text boxes, drop-down menus, and buttons, any means for inputting data into a user interface can be used.

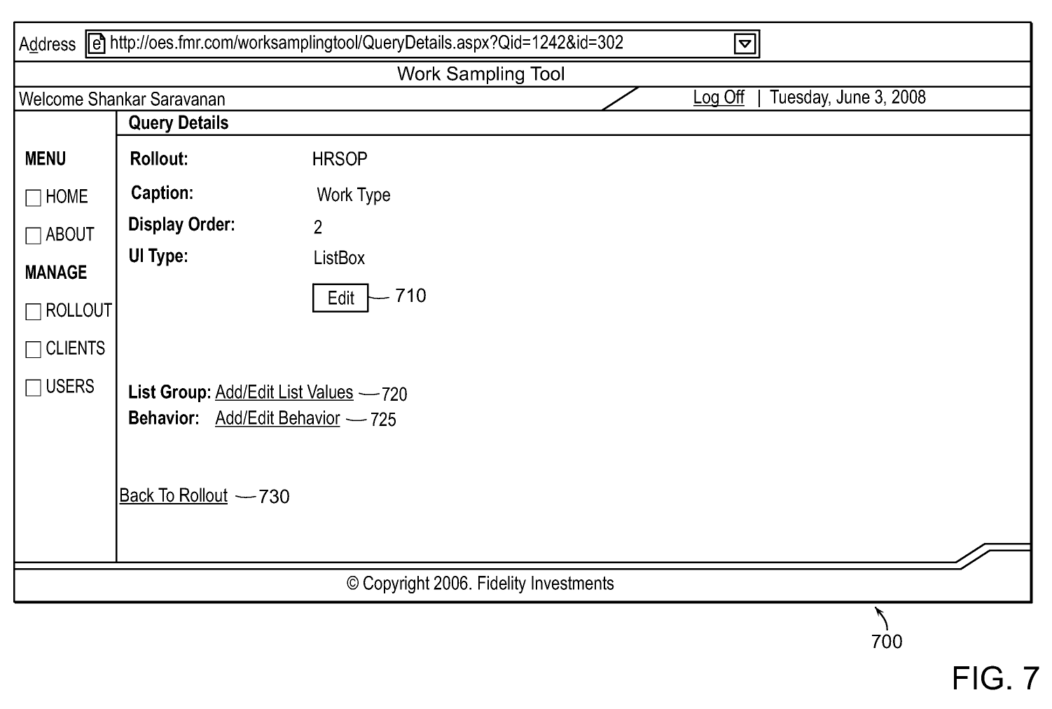

In some examples, the administrator enters a caption indicating the query type into the caption field 610, such as “Work Type,” “Activity,” “Function,” “Applications,” “Customer,” “Request Type,” “Client,” “Interaction Type,” “Interaction Sub-type.” The caption appears as a header over the query when displayed by the process sampling module. The administrator enters a number into the display order field 615 to indicate the numerical order in which the query appears when displayed by the process sampling module. For example, if the display order is 1, the query appears as the first query when displayed by the process sampling module. If the display order is 2, the query appears as the second query when displayed by the process sampling module, and so on. The administrator selects the user interface type from the user interface type field 616 by, for example, selecting a type from a drop-down menu. The selected user interface type indicates the means through which the process study participant enters data for the query. In this embodiment, the user interface type can be a text book, a drop-down menu or list, a list box, a check box, a check box group, a multi-line text book, or a timer, though other types of user interface types can be used. After the administrator finishes entering the desired information for the caption field 610, the display order field 615, and the user interface (UI) type drop-down menu 620, the administrator saves the information by clicking the insert query button, and the system then generates screenshot 700 of FIG. 7.

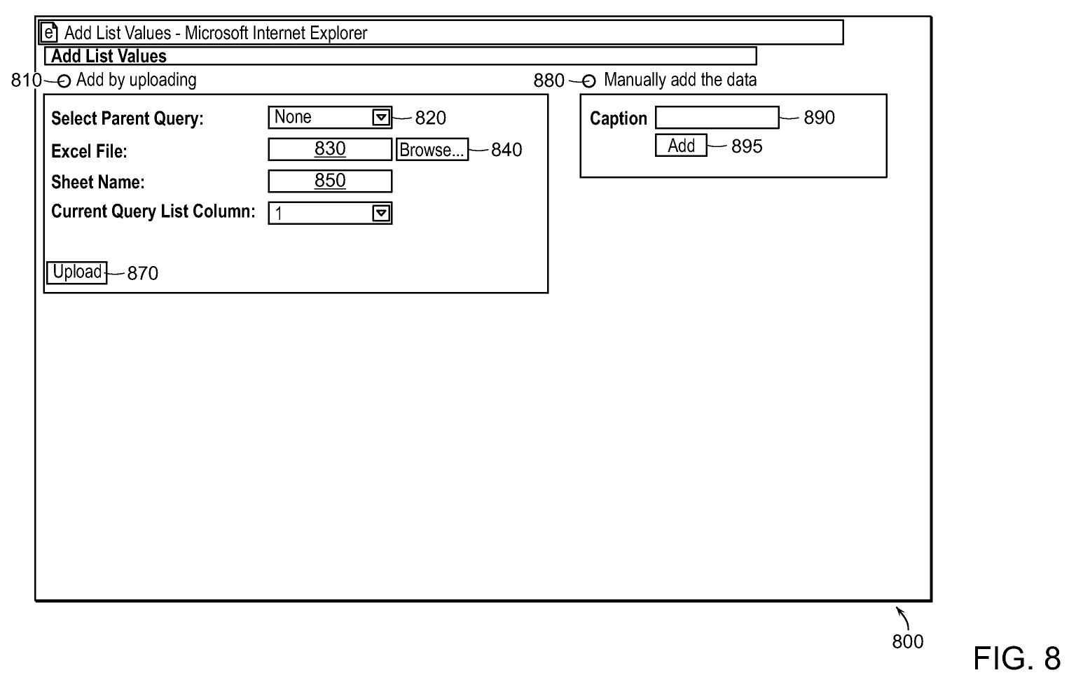

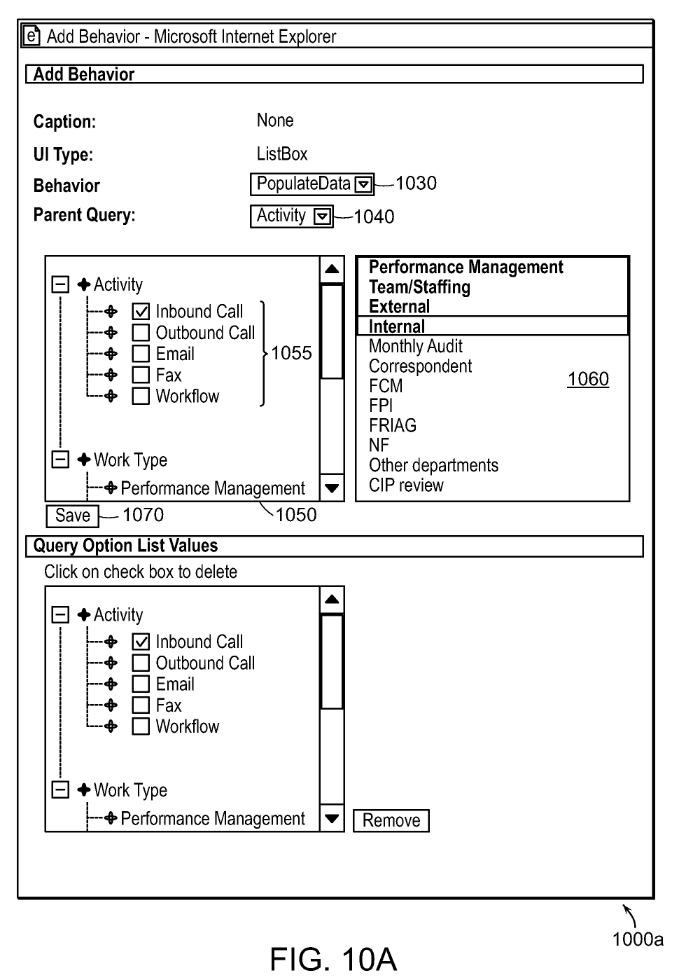

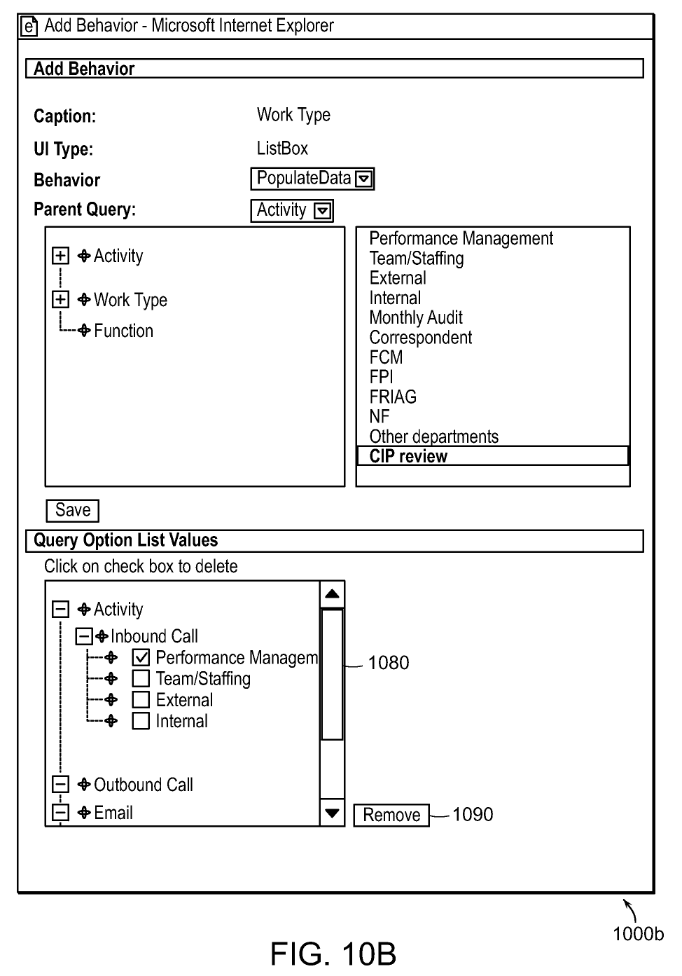

FIG. 7 is a screenshot 700 of an exemplary administrator interface displayed on the administrator site 110 for editing or configuring a query. Screenshot 700 includes an edit query button 710, an add/edit list values button 720, an add/edit behavior button 725, and a back to rollout button 730. In a preferred embodiment, the add/edit behavior button 725 is invisible when the display order of the query is 1 as the first query will not be configured to depend on another query. Selecting the edit query button 710 causes the system 100 to generate an administrator interface, such as screenshot 600, from which the administrator can edit information related to the query. Selecting the add/edit list values button 720 causes the system 100 to generate an administrator interface, such as screenshot 800 in FIG. 8, from which the administrator can add entries for the query and, in some examples, configure relationships between queries by the way the entries are added. Selecting the add/edit behavior button 725 causes the system 100 to generate an administrator interface, such as screenshot 1000a in FIG. 10A, from which the administrator can manually configure relationships between queries. Selecting the back to rollout button 730 causes the system 100 to generate an administrator interface, such as screenshot 400, from which the administrator can then elect to edit the rollout, specify participants for the process sampling study by adding them, add another query, or any other like function.

FIG. 8 is a screenshot 800 of an exemplary administrator interface displayed on the administrator site 110 for adding entries to a query. Screenshot 800 includes an add by uploading button 810, a select parent query field 820, an Excel file field 830, a browse button 840, a sheet name field 850, an upload button 870, a manually add the data radio button 880, a caption field 890, and an add button 895. In some examples, the interface permits the administrator to add entries to the query by manually entering individual entries or uploading entries from a file. Although the screenshot 800 displays particular fields as text boxes, drop-down menus, radio buttons, and buttons, any means for inputting entries into a user interface can be used.

Selection of the manually add the data radio button 880 enables the administrator to add individual entries to the query manually, whereas selection of the add by uploading button 810 enables the administrator to upload a file with entries to be added to the query. Selection of one radio button disables the ability to select the other and the ability to enter data into the fields associated with the unselected radio button.

If the administrator elects to add entries to the query individually, after selecting the manually add the data radio button 880, the administrator inputs an entry into the caption field 890 and clicks the add button 895. The entry can be added to the query and appear on the process sampling module in the order in which the entry is entered.

If the administrator elects to add multiple entries saved in a file to the query, the administrator can upload the file. The file can include entries for a single query or entries for two queries that indicate the relationship between the queries (e.g. parent and child queries). In either case, the administrator first selects the add by uploading radio button 810.

If the file includes entries for a single query, the administrator sets the parent query field 820 to “None.” In this example, the administrator enters the name of the file by typing the name into the Excel file field 830 or by searching for the file. By clicking on the browse button 840, the administrator can search through file directories and select the desired file when found. The name of the selected file then appears in the Excel file name field 830. If desired, the administrator can also enter a sheet name in the sheet name field 850 to distinguish the file being uploaded from others that have or will be uploaded. The administrator then selects the upload button 870 to submit the file to the network server 115. The network server 115 reads the file, parses the contents of the file into entries for the query, and stores the entries for the query on the storage unit 130. If the file cannot be parsed, the screenshot 800 displays an error message to the administrator.

If the file includes entries for two queries that also indicates the relationship between the queries, the administrator sets the parent query field 820 to the caption for the parent query. The steps to upload the file remain the same as if the file included data for a single query. The network server 115 reads the file, parses the contents of the file into entries for the parent query and entries for the child query as the entries relate to that for the parent query, and stores all of the information on the storage unit 130. If the file cannot be parsed, the screenshot 800 displays an error message to the administrator.

After the administrator finishes adding entries to the query, the administrator can return to a site such as screenshot 400, from which the administrator can then elect to edit the rollout, specify participants to the process sampling study by adding them, add another query, or any other such function that would be obvious to one of ordinary skill.

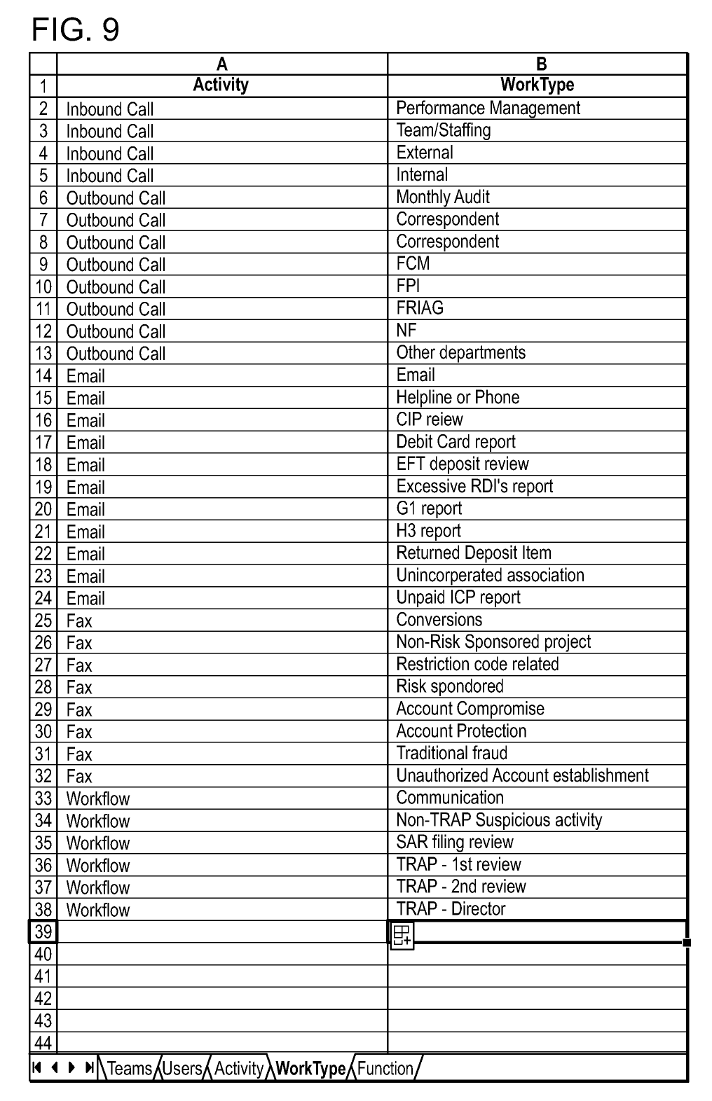

FIG. 9 is an exemplary file including entries for two queries that also indicates the relationship between the queries. In this example, the file includes the entries that appears for the query “WorkType” when the participant has selected “Inbound Call,” “Outbound Call,” “Email,” “Fax,” or “Workflow” for the Activity query, respectively.

FIG. 10A is an exemplary screenshot 1000a of an exemplary administrator interface displayed on the administrator site 110. The system 100 generates such as screenshot 1000a in response to, for example, clicking the add/edit behavior button 725 of screenshot 700. Through screenshot 1000a, the administrator can manually configure a relationship between a parent query and a child query. For example, an Activity query can include more than one activity, and a WorkType query can include all the types of work associated with the various Activities. In some examples, however, when the participant selects one activity for the Activity query, only a subset of entries in the WorkType query will be relevant. The administrator can configure the process study so that only the relevant entries in the WorkType query are visible and selectable when the participant selects a particular Activity in the process sampling module. Advantageously, this presentation of only the relevant entries in subsequent queries simplifies the task of entering data about the process being sampled.

Screenshot 1000a displays the caption and user interface type of the query. Screenshot 1000a also includes a behavior field 1030, a parent query field 1040, a menu 1050 displaying entries for the selected parent query 1055, a menu 1060 displaying entries for the child query, and a save button 1070.

The caption field 1010 and user interface type field 1020 display, respectively, the caption and user interface of the child query. To create a relationship between the parent query and the child query, the administrator selects “PopulateData” from the behavior field 1030 and inputs a query in the parent query field 1040. The menu 1050 automatically scrolls to the selected parent query and displays the entries for the parent query. In this example, the entries for the parent query are displayed in an expanded tree structure, though other arrangements for presenting the entries can be used.

In some examples, the administrator configures the process study by creating a relationship between the entries for parent query and the child query. In some examples, the administrator first selects one of the entries for the parent query, and in this example, the “Inbound Call” is selected for the Activity by selecting the check box next to “Inbound Call.” Then, the administrator selects from the menu 1060 a subset of the entries for the child query to associate with the selected entry for the parent query. In this example, of the Work Types, the administrator has associated “Performance Management,” “Team/Staffing,” “External,” and “Internal” with the “Inbound Call” Activity. The administrator clicks on the save button 1070 to save the relationship. Then, when a participant selects “Inbound Call” for the Activity on the process sampling module, the process sampling module will display “Performance Management,” “Team/Staffing,” “External,” and “Internal” under the Work Type query. The remaining, irrelevant entries for Work Type will be hidden from view.

FIG. 10B is an exemplary screenshot 1000b of an exemplary administrator interface displayed on the administrator site 110. The screenshot 1000b demonstrates configuring the relationship between the parent query and the child query by deleting an association. The screenshot 1000b includes a process sampling study data menu 1080 and a remove button 1090. The administrator uses the features of screenshot 1000b to deleted previously saved relationships between a parent query and a child query.

In this example, the administrator has selected the “Inbound Call” for the parent Activity query. Due to the previously saved relationship between the “Inbound Call” and the selected subset of entries for Work Type, the “Inbound Call” expands to reveal the selected subset (“Performance Management,” “Team/Staffing,” “External,” and “Internal”) with a check box associated with each entry. The administrator can select the check box associated with, for example, “Performance Management” and click the remove button 1090 to delete the association between “Inbound Call” and “Performance Management.” “Performance Management” will disappear from the list of entries associated with “Inbound Call” in the process sampling study data menu 1080.

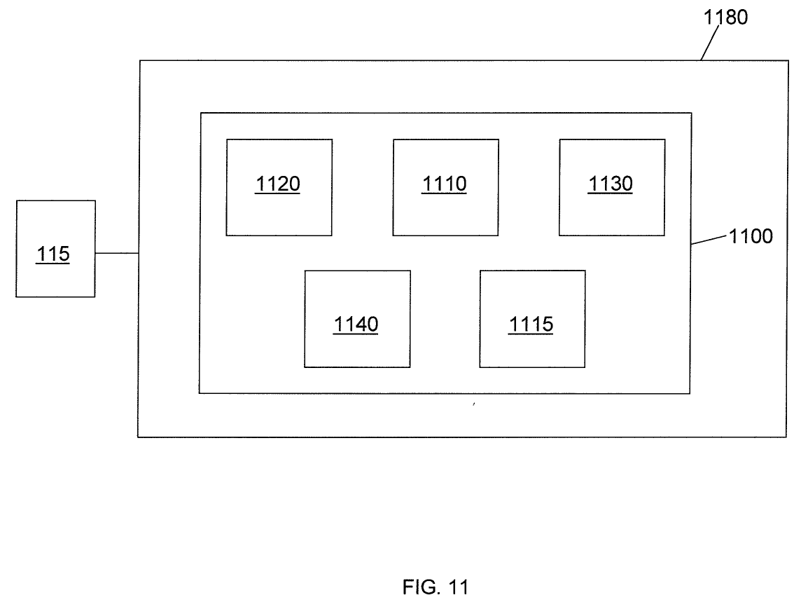

FIG. 11 is a block diagram of an exemplary process sampling module 1100 present on a participant's end client computing device 1180 that communicates with the network server 115. The process sampling module 1100 includes a user interface generating module 1110, a rollout information module 1115, a communication module 1120, a participant information module 1130, and a data storage module 1140. The user interface generating module 1110 displays the queries of one process study at a time and receives data entered by the participant. The rollout information module 115 stores information about the rollouts on the process sampling module 1100. For example, for each rollout, the rollout information module 115 can store information about the user interface layout, the queries, or any other information. The communication module 1120 enables the process sampling module 100 to communicate with the end client computing device 1180 and/or the network server 115. The participant information module 1130 stores information about the participant. For example, the participant module 1130 can store the participant's corporate identification number and the process studies the participant is enrolled in. The data storage module 1140 stores data entered by the participant in response to queries when the end client computing device 1180 cannot communicate with the network server 115. The modules can be combined or separated in any configuration. For example, the rollout information module 115 and the participant information module 1130 can be combined into one module. In another example, the rollout information module 115 can be split into separate modules, wherein one module stores information about the user interface layout for the rollout and the other module stores the queries of the rollout. As noted below, modules can be implemented via software and/or hardware, which can be part of the computing device.

As previously discussed, the administrator of a process study sends a mail message with a link to each participant, and the participant clicks on the link to download and install the process sampling module 1100 on his or her end client computing device 1180. If the end client computing device 1180 does not yet include a process sampling module, the download installs a new process sampling module 1100 on the end client computing device 1180. If the end client computing device 1180 already has a process sampling module 1100′, the download adds information about the new rollout to the rollout information module 115 and updates in the participant module 1130 the record of the process studies the participant is enrolled in. The process sampling module 1100′ permits the participant to close and temporarily inactivate one rollout and open and activate another rollout, and the opened rollout will begin or resume collecting process sampling data. In some examples, a participant in multiple process sampling studies can have responsibilities related to accounting or transaction processing as part of his or her job. The participant can close the accounting-focused rollout and open the transaction processing-focused rollout when the participant intends to focus upon transaction processing tasks. Likewise, the participant can re-open the accounting-focused rollout and submit process sampling data related to accounting when the participant switches to his or her accounting responsibilities. In some examples, when the process sampling module 1100′ collects process sampling data for the first time that day, the processing sampling module 1100′ enables the participant to select which process study to partake in.

On the beginning date of the process study, the rollout begins collecting process sampling data from the participant. The process sampling module 1100 signals (e.g. flashes, pops-up, beeps, clicks) the participant to enter data through the user interface module 1110, which displays the queries of the process study. The participant selects the entries for each query appropriate to the process he or she is performing and submits the data. The process sampling module 1100 stores the data, discussed in further detail below, and minimizes itself on the end client computing device 1180, thereby providing a minimal amount of disruption to the participant's work. If the administrator checked the random popup check box 335 (FIG. 3) when configuring the process study, the process sampling module 1100 signals the participant to enter process sampling data according to the randomized, response frequency of the study. If the administrator did not check the random popup check box 335 when configuring the study, the participant opens the module and enters data at will.

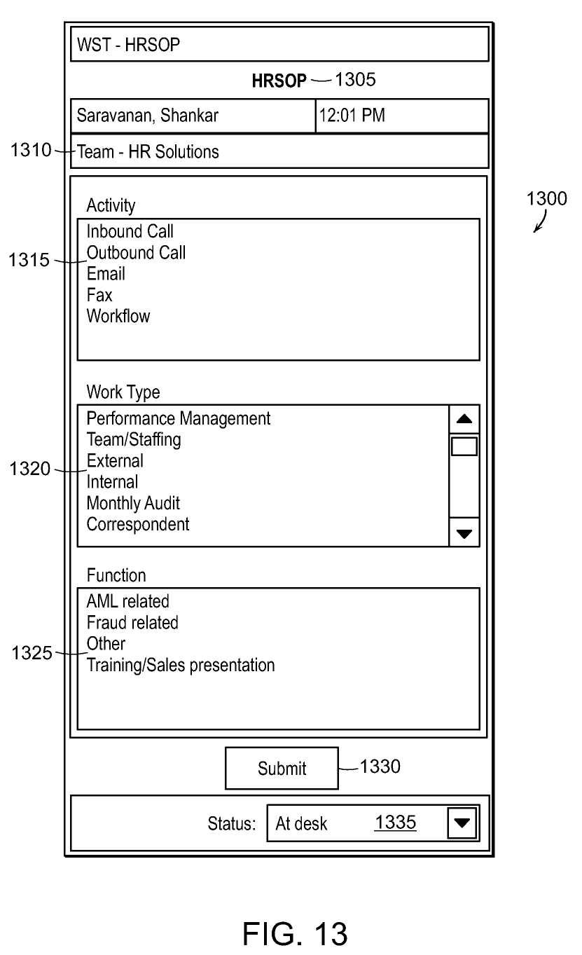

If the administrator checked the status panel check box 330 (FIG. 3) when configuring the process study, the participant can activate and deactivate the process sampling module 1100 according to the participant's availability. For example, checking the status panel check box 330 can create a drop-down menu in the rollout with active and inactive statuses (see e.g., 1135, FIG. 13, and its description below). An active status can be “working” or “at desk,” whereas an inactive status can be “out of office,” “away,” or “at meeting.” In some examples, when the participant sets the status to “at desk,” the process sampling module 1100 continues collecting process sampling data according to the response frequency of the study. However, if the participant leaves his or her desk for a videoconference in another room, the participant can set the status to “at meeting.” While the status remains “at meeting,” the process sampling module 1100 does not seek to collect process sampling data.

However, when the participant returns and sets the status to “at desk,” the process sampling module 1100 can signal for process sampling data. The participant can enter data about the process he or she has just taken part in. In some embodiments, the process sampling module 1100 can wait a predetermined amount of time (e.g. two minutes, five minutes, etc.) before signaling for process sampling data. In general, whenever the status of the process sampling module 1100 is changed from an inactive status to an active status, the process sampling module 1100 signals for process sampling data within a predetermined amount of time. If no data is entered within another predetermined amount of time, the process sampling module 1100 registers a non-response.

Each time the process sampling module 1100 receives process sampling data or registers a non-response, the process sampling module 1100 attempts to transmit the data over the network 125 to the network server 115. The communication module 1120 determines if the end client computing device 1180 can communicate with the network server 115, e.g., whether the end client computing device 1180 is on-line. If the end client computing device 1180 cannot communicate with the network server 115, the data storage module 1140 stores the process sampling data or non-response on the end client computing device 1180. In some examples, the data is stored in a specified file directory or in an XML file.

If the end client computing device 1180 can communicate with the network server 115, the process sampling module 1100 searches and retrieves stored process sampling data from the end client computing device 1180 and transmits the retrieved data and the newly received data to the network server 115. In some examples, the process sampling module 1100 designates the transmitted data for one or more process studies at the network server 115. As the process sampling module 1100 continues to collect process sampling data when the end client computing device is off-line, the participant's mobility is greatly increased without disrupting the process study's ability to collect data. As such, process sampling modules can collect data from participants in any location without being limited by the need for constant access to the network.

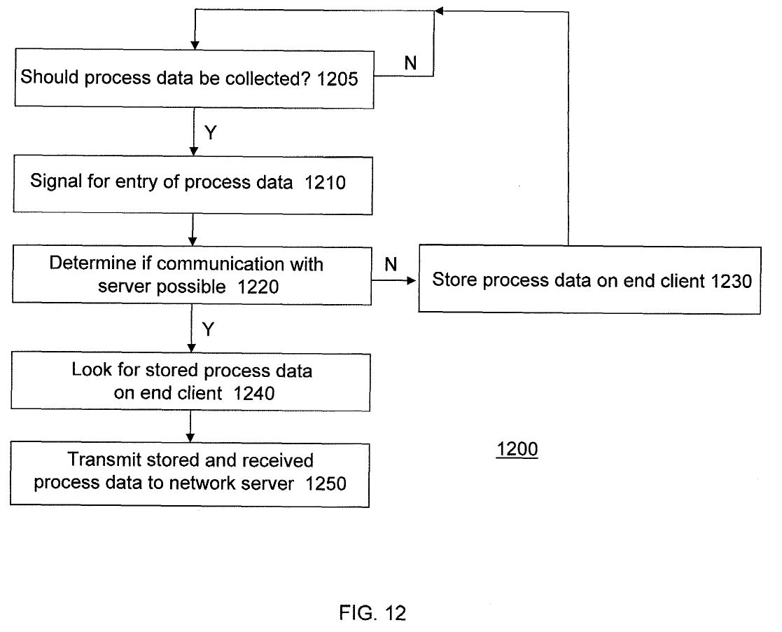

FIG. 12 illustrates an exemplary method 1200 of storing process sampling data collected by the process sampling module 1100. First, the process sampling module 1100 determines whether process sampling data should be collected for the rollout (Step 1205). If not, the process sampling module 1100 waits until process sampling data is to be collected, at which point the process sampling module 1100 signals the participant to enter process sampling data (Step 1210). The communication module 1120 determines if the end client computing device 1180 can communicate with the network server 115 (Step 1220). In some examples, the communication module 1120 makes the determination by attempting to ping the network server 115.

If the end client computing device 1180 cannot communicate with the network server 115, the data storage module 1140 stores the received process sampling data or a non-response on the end client computing device 1180 at a designated file directory (e.g. an XML file) (Step 1230). If the end client computing device 1180 can communicate with the network server 115, the process sampling module 1100 looks in the designated file directory on the end client computing device 1180 for stored process sampling data (Step 1240). The process sampling module 1100 then transmits the stored process sampling data and recently collected process sampling data over the network to the network server 115 (Step 1250). The process sampling module 1100 then resumes waiting for the next appropriate time to collect process sampling data.

FIG. 13 is an exemplary screenshot 1300 of a user interface that can be generated and displayed by the process sampling module 1100. The screenshot 1300 displays a rollout name 1305, a team name 1310, a first query 1315, a second query 1320, a third query 1325, a submit button 1330, and a status panel 1335, all of which correspond to the same rollout. In this example, the rollout name 1305 and team name 1310 correspond to the rollout being configured in the exemplary screenshot 400 of FIG. 4.

In this example, when the administrator configured the first query 1315 from, for example, screenshot 600 of FIG. 6, the administrator entered “Activity” into the caption field 610, entered “1” into the display order field 615, and selected a value of “ListBox” from the drop-down menu of the user interface type field 616. When the administrator configured the second query 1320, the administrator entered “Work Type” into the caption field 610, entered “2” into the display order field 615, and selected a value of “ListBox” from the drop-down menu of the user interface type field 616. When the administrator configured the third query 1325, the administrator entered “Function” into the caption field 610, entered “3” into the display order field 615, and selected a value of “ListBox” from the drop-down menu of the user interface type field 616.

The relationship between the first query 1315 and the second query 1320 has been configured from, for example, exemplary screenshot 1000a of FIG. 10A. The screenshot 1300 displays all the entries for the first and second queries because the participant in the process study has not selected any entries for any query. However, if the participant selects the entry “Inbound Call” for the first query 1315, the second query 1320 displays the entries “Performance Management,” “Team/Staffing,” “External,” and “Internal” in the list box and hides all other entries from view. If the administrator has configured a relationship between the second query 1320 and the third query 1325, when the participant selects an entry from the second query 1320, the third query 1325 displays some of the entries and hides other entries from view according to the configured relationship. After the participant selects entries from the first, second, and third queries, the participant clicks on the submit button 1330. The process sampling module 1100 transmits the selected entries to the network server 115 or stores the selected entries on the end client computing device, depending on the end client computing device's ability to communicate with the network server 115.

The status panel 1335 appears because, for example, the administrator checked (e.g. used a pointing device to move a cursor over the selected box and pressed a button on the pointing device) the status panel check box 330 when creating the rollout using the exemplary screenshot 300 of FIG. 3. The participant can select a value from the drop-down menu of the status panel 1335 to activate or deactivate the process sampling module 1100. In this example, the process sampling module 1100 is activated because the status is “At desk.” The participant can set the status panel to, for example, “Away” or “At meeting” to deactivate the process sampling module 1100 so the module 1100 does not seek to collect process sampling data.

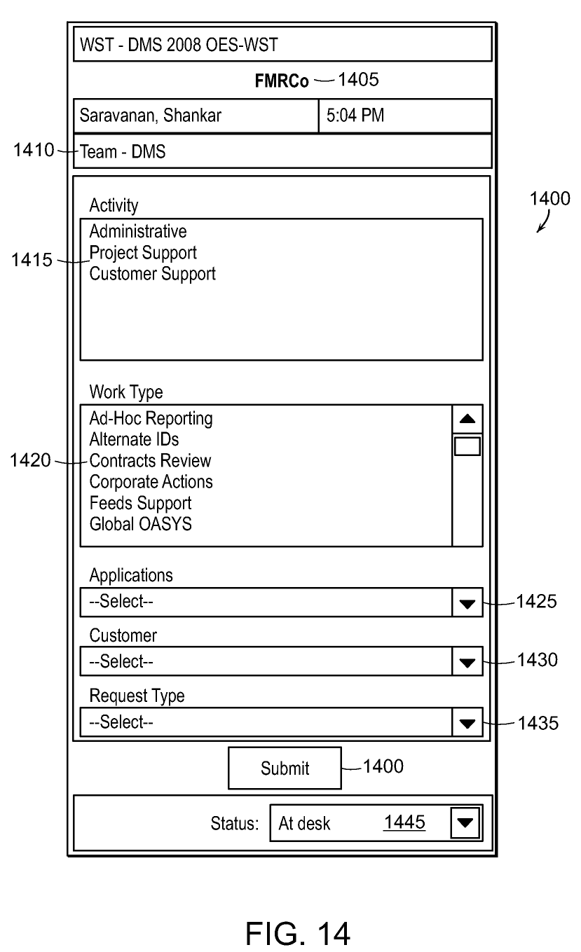

FIG. 14 is another exemplary screenshot 1400 of a user interface that can be generated and displayed by the process sampling module 1100. The screenshot 1400 displays a rollout name 1405, a team name 1410, a first query 1415, a second query 1420, a third query 1425, a fourth query 1430, a fifth query 1435, a submit button 1440, and a status panel 1445, all of which correspond to the same rollout. The rollout corresponding to the screenshot 1400 has been configured in a similar manner as the rollout corresponding to the screenshot 1300.

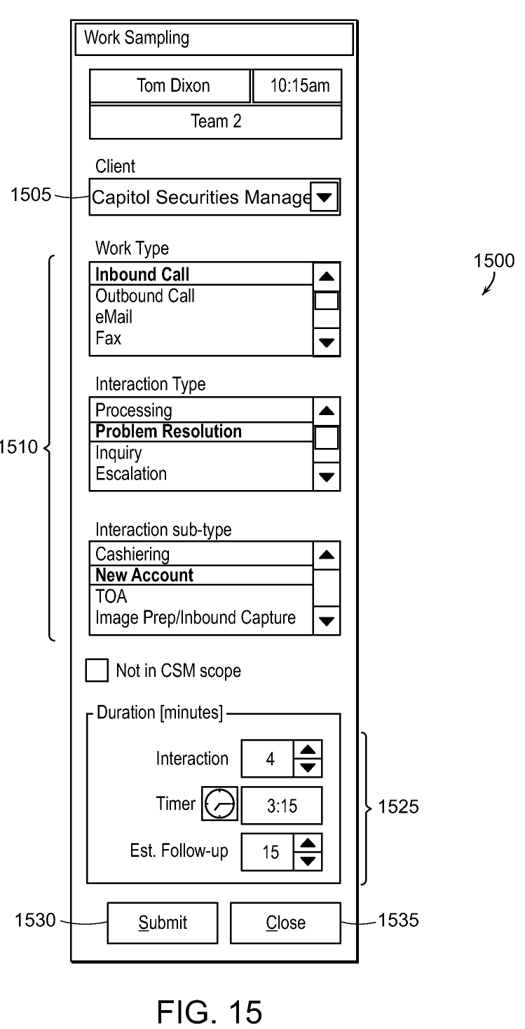

FIG. 15 is yet another exemplary screenshot 1500 of a user interface that can be generated and displayed by the process sampling module 1100. The screenshot 1500 displays a client drop down menu 1505, queries 1510 associated with a selected client, a custom randomization panel 1525 associated with the selected client, a submit button 1530, and a close button 1535.

In this example, the user is a participant in multiple process studies. The user selects which rollout to activate by selecting a client from the client drop down menu 1505, and the screenshot 1500 displays the rollout associated with the selected client. The user can select a different rollout by selecting a different client from the drop down menu 1505. In this example, the user has selected the client “Capitol Securities Management.” In this example, when the administrator created the rollout for Capitol Securities Management, the administrator added three queries and, for example, did not select the random popup check box 335 on screenshot 300 of FIG. 3. As a result, the rollout includes the custom randomization panel 1525. The participant can enter process sampling data by selecting entries for the queries and clicking the submit button 1530. The participant can minimize the screenshot 1500 by clicking on the close button 1535, and reopen the process sampling module 1100 when the user next wishes to input process sampling data. The participant can also set the next time the process sampling module 1100 signals for data. For example, the participant can enter a value for “Est. Follow-up” when the participant selects entries for the queries. The participant submits this time with the entries, and the process sampling module 1100 signals for data at the selected time.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. The memory devices can include persistent memory. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile and/or persistent memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computing device having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier Internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks. Communication networks can include packet-based networks and/or circuit-based networks.

The computing device can include, for example, a thin client device, a touch screen computing device, a computer, a computer with a browser device, a telephone, an IP phone, a mobile wireless computing device (e.g., cellular phone, personal digital assistant (PDA) device, laptop computer, electronic message device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method of configuring a process sampling module comprising the steps of:
receiving a first set of information associated with a first query at a computing device that is generating an administrator interface;
storing the first set of information in persistent memory to set entries for the first query based on the first set of information;
receiving a second set of information associated with a second query at the computing device that is generating the administrator interface;
storing the second set of information in persistent memory to set entries for the second query based on the second set of information;
creating and storing in persistent memory a relationship between an entry for the first query and a subset of the entries for the second query; and
using the entries for the first query, the entries for the second query, and the relationship to create the process sampling module for collecting process data for a process study.

2. The method of claim 1, further comprising setting the randomization of the process sampling.

3. The method of claim 2, wherein the randomization is a cycle time for a process sample.

4. The method of claim 2, wherein the randomization is a predetermined number of process samples in a predetermined period of time.

5. The method of claim 2, wherein the randomization is entry at will.

6. The method of claim 1, further comprising setting the period of time for which the processing sample module will be active.

7. The method of claim 1, further comprising setting the means for selecting the entry for the first query or the second query.

8. The method of claim 1, further comprising specifying the participants who will use the process sampling module.

9. The method of claim 8, wherein specifying the participants comprises uploading a file.

10. The method of claim 8, wherein specifying the participants comprises entering individual participants.

11. The method of claim 1, further comprising setting the order of the queries.

12. A computing device configured to receive a first set of information to set entries for a first query, a second set of information to set entries for a second query, and a relationship between an entry for the first query and a subset of the entries for the second query.

13. The computing device of claim 12, further comprising means for setting the randomization of process sampling.

14. The computing device of claim 13, wherein the randomization is a cycle time for a process sample, a predetermined number of process samples in a predetermined period of time, or entry at will.

15. The computing device of claim 12, further comprising means for setting a period of time for which a processing sample module will be active.

16. The computing device of claim 12, further comprising means for setting a method of selecting the entry for the first query or the second query.

17. The computing device of claim 12, further comprising means for specifying a participant who will use a process sampling module.

18. The computing device of claim 17, wherein the means for specifying the participant uploads a file of participants or enters individual participants.

19. The computing device of claim 12, further comprising means for setting the order of the queries.

20. (canceled)

21. An administrator interface for configuring a process sampling module comprising:
means for displaying entries for a first query on a computer;
means for displaying entries for a second query on a computer;
means for creating and storing in persistent memory a relationship between an entry for the first query and a subset of the entries for the second query.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
